(19) United States
(12) Patent Application Publication
(10) Pub. No.: US 2026/0086780 A1
(43) Pub. Date: Mar. 26, 2026

(54) METHOD FOR GENERATING APPLICATION PROGRAM USING NATURAL LANGUAGE MODEL AND NON-VOLATILE RECORDING MEDIUM FOR STORING INSTRUCTIONS FOR PERFORMING THE METHOD

(71) Applicant: TOBESOFT CO. LTD, Seoul (KR)

(72) Inventors: Woo Cheol LEE, Seoul (KR); Hyun Jung GO, Suwon-si (KR); Seok Lyul KO, Hwaseong-si (KR); Jeong Beom PARK, Seoul (KR)

(73) Assignee: TOBESOFT CO. LTD, Seoul (KR)

(21) Appl. No.: 19/301,014

(22) Filed: Aug. 15, 2025

(30) Foreign Application Priority Data
Sep. 25, 2024 (KR) 10-2024-0130317

(51) Int. Cl. G06F 8/35; G06N 20/00

(52) U.S. Cl. CPC G06F 8/35; G06N 20/00

(57) ABSTRACT

A method for generating an application program according to an embodiment disclosed herein includes inputting a natural language command through a developer input interface from a developer who develops the application program, inputting the input natural language command into a predetermined language model, acquiring predetermined output information generated by the language model in response to the input of the natural language command, and generating a source code or an execution code of the application program using the acquired output information.

### CROSS REFERENCE TO RELATED APPLICATION

The present application claims the right of priority to and the benefits of Korean Application No. 10-2024-0130317 having a filing date of Sep. 25, 2024, the content of which is hereby incorporated by reference in its entirety.

### BACKGROUND OF THE INVENTION

### 1. Field of the Invention

The present invention relates to a method for developing computer application software, and more specifically, to a program for developing an application using a natural language model such that a developer may easily develop computer application software.

### 2. Description of the Related Art

Low-code development is a software development approach that helps develop application programs quickly with minimal manual coding. This approach helps developers easily create applications.

The low-code development method according to the related art provides the following characteristics. First, an application may be visually configured through a drag-and-drop interface, and a visual development environment capable of configuring screen design and logic flow may be provided without writing complex code. Second, the application may be quickly configured by utilizing pre-made reusable components and templates, and these components may include database connections, user interface elements, business logic, and the like. Third, backend operations such as interworking with a database, API calls, authentication, and rights management may be automated and easily set, and accordingly, development time and complexity may be reduced. Fourth, an idea may be quickly implemented as a prototype, so that it is possible to quickly receive initial feedback, which matches agile development methodology well. Fifth, user-defined codes may be added as needed, thereby expanding basic functions of a low-code platform, and functions may be personalized according to specific requirements, thereby providing flexibility and extensibility.

Examples of the low-code platform include Mendix provided by Siemens, OutSystems, which is a low-code platform for web and mobile application development, Microsoft Power Apps, which is a low-code platform of Microsoft for easily creating business applications, and Appian, which is a platform in which business process management is combined with low-code development.

The number of cases of developing low-code software using a large language model (LLM) that performs natural language processing is being increased, which contributes greatly to making the development process simpler and more efficient. The cases usually have the following characteristics. First, the developer explains the requirements of the application in natural language, and the LLM understands the requirements and automatically generates codes or components that may be used on the low-code platform. For example, when “Please create a user login screen” is input, a code related to a login form is automatically generated. Second, the function and usage of the code may be documented in natural language through the LLM. After writing the code, when the developer simply adds a description, the LLM automatically creates a detailed document. For example, when short description of the function or module is written, the LLM generates a detailed document based on the short description. Third, when a user asks a question in natural language during the development process, the LLM provides an immediate answer or proposes a related code. For example, the LLM provides a specific code example for the question “How do I save it to the database when I click this button?”.

Some cases of low-code software development using the large language model (LLM) that performs natural language processing are as follows. First, Microsoft Power Apps are a low-code platform, and recently support development using natural language processing by integrating OpenAI's GPT-3. When the user explains the requirements in natural language, the GPT-3 understands the requirements and proposes appropriate Power Apps components and logic. For example, when the developer inputs “I want to create an app that looks up customer data,” the GPT-3 understands the requirement and automatically creates a form that is linked to the customer database. When a specific operation is described, for example, when it is referred to as “addition of a button to update the order status”, the GPT-3 interprets the requirement and adds a button having the corresponding function to the app. Second, UiPath is a low-code/no-code automation platform that provides a robotic process automation (RPA) solution. The UiPath integrates an LLM such as GPT-3 such that an automated workflow may be created through natural language processing. For example, when the developer inputs a natural language command such as “Check e-mails every morning and classify important e-mails”, the GPT-3 interprets the requirement and the automated robot of the UiPath creates a workflow to perform the requirement. The business processes are automated by generating automation scripts based on the requirements written in natural language. Third, Salesforce Einstein is an AI platform of Salesforce and provides various AI functions. The Salesforce Einstein supports the development of natural language-based low-code applications by integrating GPT-3. For example, when the developer inputs “Create a new lead generation form”, GPT-3 interprets the requirement and automatically generates a form necessary in the Salesforce environment. When a customer support scenario is described in natural language, the GPT-3 generates a necessary data model and UI based on the description. In each of the above-described cases, a specific main configuration in which each platform supports application development by processing the input natural language is not disclosed.

### SUMMARY OF THE INVENTION

An object of the present invention is to provide an application development program for generating an application using a natural language command input by a developer such that the developer of the application may easily develop the application.

According to one aspect of the present invention, there may be provided a method for generating an application program, including: inputting, by a computing device, a natural language command through a developer input interface from a developer who develops the application program; inputting, by the computing device, the input natural language command into a predetermined language model (LM); acquiring, by the computing device, predetermined output information generated by the language model in response to the input of the natural language command; and generating, by the computing device, a source code or an execution code of the application program using the acquired output information.

In this case, the output information may include: a model object (F) configured to generate a table including information about a user input component for receiving a data filtering condition from the user of the application program; the model object (O) configured to generate the table including the data required by the user; a view template object (F) used to generate a condition input window including the user input component; the view template object (O) used to output the data required by the user on the screen in a predetermined expression format; and the action object configured to filter the data required by the user using the data filtering condition to output the filtered data, which is prepared by filtering, on the screen in the predetermined expression format, and

In this case, the language model may have been subject to supervised learning, and a method of the supervised learning may include: preparing a plurality of training natural language sentences to be input into the language model; preparing labels for each of the plurality of prepared training natural language sentences; and performing supervised learning on the language model by using the plurality of prepared training natural language sentences and a plurality of labels prepared to correspond to the plurality of prepared training natural language sentences.

In this case, the output information may include: a model object (F) configured to generate a table including information about a user input component for receiving a data filtering condition from the user of the application program; the model object (O) configured to generate the table including the data required by the user; a view template object (F) used to generate a condition input window including the user input component; the view template object (O) used to output the data required by the user on the screen in a predetermined expression format; and the action object configured to filter the data required by the user using the data filtering condition to output the filtered data, which is prepared by filtering, on the screen in the predetermined expression format, and In this case, each of the labels may be configured in a combination of: any one of words representing a plurality of pre-prepared model objects (F); any one of words representing a plurality of pre-prepared model objects (O); any one of words representing a plurality of pre-prepared view template objects (F); any one of words representing a plurality of pre-prepared view template objects (O); and any one of words representing a plurality of pre-prepared action objects.

According to another aspect of the present invention, there may be provided a non-volatile recording medium recorded with an application development program that causes a computing device to generate an application program. The application development program may include instructions that cause the computing device to execute the steps of: inputting a natural language command through a developer input interface from a developer who develops the application program; inputting the input natural language command into a predetermined language model; acquiring predetermined output information generated by the language model in response to the input of the natural language command; and generating a source code or an execution code of the application program using the acquired output information.

In this case, the output information may include: a model object (F) configured to generate a table including information about a user input component for receiving a data filtering condition from the user of the application program; the model object (O) configured to generate the table including the data required by the user; a view template object (F) used to generate a condition input window including the user input component; the view template object (O) used to output the data required by the user on the screen in a predetermined expression format; and the action object configured to filter the data required by the user using the data filtering condition to output the filtered data, which is prepared by filtering, on the screen in the predetermined expression format.

In this case, the language model may have been subject to supervised learning, and a method of the supervised learning may include: preparing a plurality of training natural language sentences to be input into the language model; preparing labels for each of the plurality of prepared training natural language sentences; and performing supervised learning on the language model by using the plurality of prepared training natural language sentences and a plurality of labels prepared to correspond to the plurality of prepared training natural language sentences.

In this case, the output information may include: a model object (F) configured to generate a table including information about a user input component for receiving a data filtering condition from the user of the application program; the model object (O) configured to generate the table including the data required by the user; a view template object (F) used to generate a condition input window including the user input component; the view template object (O) used to output the data required by the user on the screen in a predetermined expression format; and the action object configured to filter the data required by the user using the data filtering condition to output the filtered data, which is prepared by filtering, on the screen in the predetermined expression format, and In this case, each of the labels may be configured in a combination of: any one of words representing a plurality of pre-prepared model objects (F); any one of words representing a plurality of pre-prepared model objects (O); any one of words representing a plurality of pre-prepared view template objects (F); any one of words representing a plurality of pre-prepared view template objects (O); and any one of words representing a plurality of pre-prepared action objects.

According to the present invention, it is possible to provide an application development program for generating an application using a natural language command input by a developer such that the developer of the application may easily develop the application.

### BRIEF DESCRIPTION OF THE DRAWINGS

FIG. 1 is a diagram explaining a concept of an application program to be developed by a developer and provided to a user according to one embodiment of the present invention.

FIG. 2 is a flowchart illustrating a method for developing an application program executed by a computing device, which is provided according to one embodiment of the present invention.

FIG. 3A is a diagram illustrating an example of a table that may be prepared by a model object (F), which is provided according to one embodiment of the present invention.

FIG. 3B is a diagram illustrating another example of the model object (F) expressed in a table format, which is provided according to one embodiment of the present invention.

FIG. 4A is a diagram illustrating a process of preparing a new table from a pre-prepared group of tables by a pre-prepared model object (O) according to one embodiment of the present invention.

FIG. 4B is a diagram illustrating a process of preparing a new table from a pre-prepared group of tables by a pre-prepared model object (F) according to one embodiment of the present invention.

FIG. 4C is a diagram illustrating a concept in which tables, which are generated by the pre-prepared model object (O) and model object (F), respectively, are used to generate a condition input window and a condition output window of FIG. 1, according to one embodiment of the present invention.

FIG. 5 is a diagram illustrating still another example of the application program shown in FIG. 1.

FIG. 6 is a diagram illustrating an example of the plurality of expression methods.

FIG. 7 is a diagram illustrating various types of design templates of a visualization format associated with a view template object (O) that is selected by an LM provided according to one embodiment of the present invention.

FIG. 8 is a flowchart illustrating a language model learning method provided according to one embodiment of the present invention.

FIG. 9 is a diagram illustrating two mutually different model objects (F) that may be output by the LM.

FIGS. 10A and 10B are diagrams illustrating examples of a screen output by an application program generated by the processing engine using the output information.

FIG. 11 is a diagram illustrating an example of a screen output by an application program generated by the processing engine using the output information, which is provided according to one embodiment of the present invention.

FIG. 12 is a functional block diagram illustrating a configuration of an application development program, which is provided according to one embodiment of the present invention.

### DETAILED DESCRIPTION OF THE INVENTION

Hereinafter, embodiments of the present invention will be described with reference to the accompanying drawings. However, the present invention is not limited to the embodiments described herein and may be implemented in various other forms. The terms used in the present specification are intended to help understanding of the embodiments, and are not intended to limit the scope of the present invention. In addition, singular forms used below also include plural forms unless the phrases clearly indicate the opposite meaning.

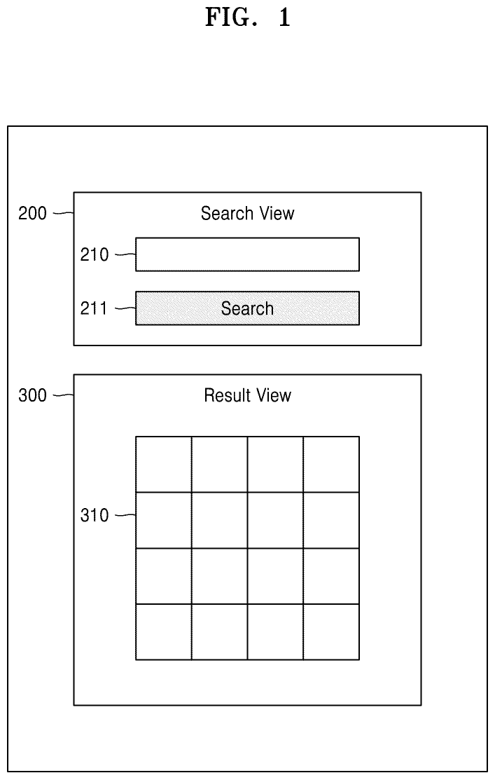

FIG. 1 is a diagram explaining a concept of an application program to be developed by a developer and provided to a user according to one embodiment of the present invention.

When the application program is executed by a user terminal used by the user, a window 100 may be displayed on a screen of the user terminal.

The window 100 may include a filtering condition input window 200 and an output window 300.

The filtering condition input window 200 may be provided with a user input interface (=user input component) 210 for the user to input a predetermined data filtering condition. The user input component 210 may follow an expression method of any one of view templates provided in advance for various user inputs to be described below.

When the user inputs the data filtering condition to the user input component 210 and selects a trigger button 211, a predetermined action to be described below may be executed so that user output information 310 for the user may be displayed on the output window 300.

The information displayed on the window 100 may be generated according to an execution result of a predetermined processing engine based on output information output by an LM to be described below.

The user output information 310 displayed on the output window 300 may follow an expression method of any one of various view templates prepared for data outputs.

The present invention relates to an application development program that helps a developer easily and rapidly develop the application program including the window 100 shown in FIG. 1.

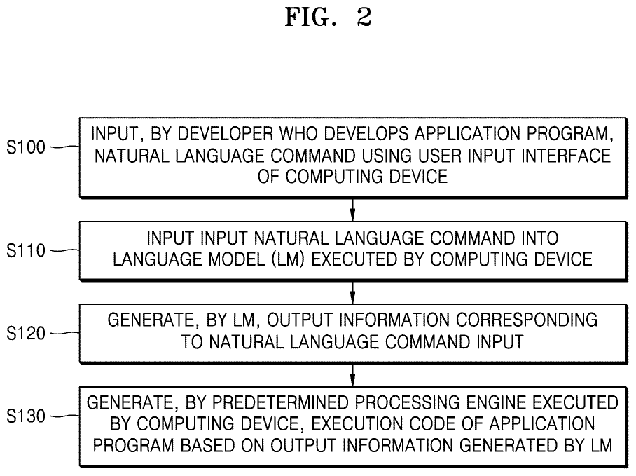

FIG. 2 is a flowchart illustrating a method for developing an application program executed by a computing device, which is provided according to one embodiment of the present invention.

The method for developing an application program may be executed by the application development program.

In step S100, a natural language command may be input by a developer who develops the application program using a user input interface (=developer input interface) of the computing device.

In step S110, the input natural language command may be input into a language model (LM) executed by the computing device.

In step S120, the LM may generate output information corresponding to the natural language command input.

In step S130, a predetermined processing engine executed by the computing device may generate an execution code of the application program based on the output information generated by the LM.

The processing engine is a type of predefined program.

Hereinafter, the method shown in FIG. 2 will be described in more detail with reference to other drawings.

In step S100 of FIG. 2, the natural language command may be a text input.

In step S100 of FIG. 2, the user input interface may be, for example, a mouse, a keyboard, or a microphone. The natural language command may be provided to the computing device by inputting text using a keyboard, or may be provided to the computing device by providing a voice input and inputting text in an STT manner. In the present specification, the user input interface used by the developer may be referred to as the developer input interface.

In step S110 of FIG. 2, the LM may be trained by an LM learning method to be described below.

The LM may be a functional module provided by a third party and may be fine-tuned by the present invention. According to one preferred embodiment, the LM may be a function module that is fine-tuned and provided by a third party.

The LM may be configured to select one or more of a plurality of pre-prepared model objects (F), select one or more of a plurality of pre-prepared model objects (O), select one or more of a plurality of pre-prepared view template objects, and select one or more of a plurality of pre-prepared action objects.

That is, the LM may output an identifier (ID) of the model object (F), an ID of the model object (O), an ID of the view template object, and an ID of the action object, which are selected by the LM.

In this case, according to one preferred embodiment, the model object (F), the model object (O), the view template object, and the action object, which are selected by the LM, may be associated with each other by the processing engine.

### <Model Object>

Each of the model object (O) and the model object (F) provided according to the present invention is a set of command codes for generating a table used to manage information to be displayed on the screen of the user terminal by the application program. The data generated by the model object may be expressed in a table format. According to the present specification, for convenience of description, the data generated by the model object may be expressed in a table format.

According to the present invention, a plurality of model objects (O) and a plurality of model objects (F) may be pre-prepared. The model object (F) may be a model object used to receive a user input from the user of the application program. The model object (O) is a model object used to prepare a data table to be processed in a specific design format and output to the user of the application program.

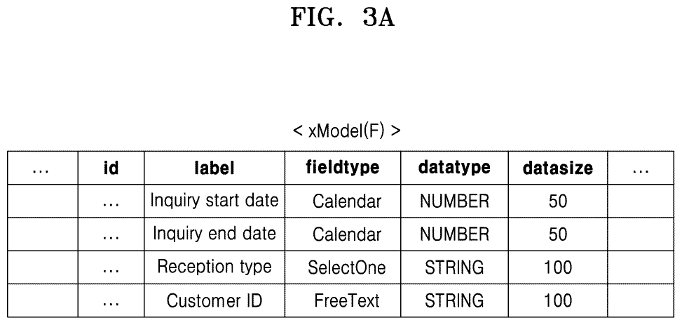

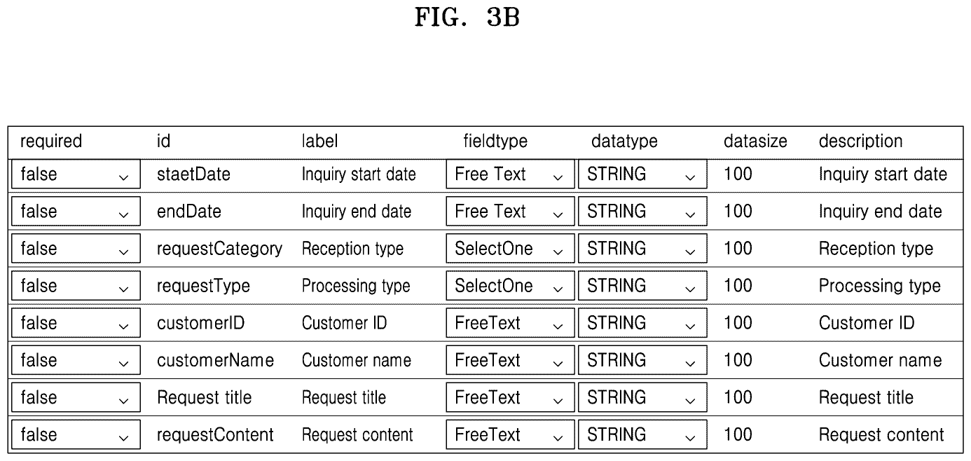

FIG. 3A is a diagram illustrating an example of a table that may be prepared by a model object (F), which is provided according to one embodiment of the present invention.

FIG. 3B is a diagram illustrating another example of the model object (F) expressed in a table format, which is provided according to one embodiment of the present invention.

The model object (F) may be expressed as a table including a plurality of records and a plurality of fields.

According to one preferred embodiment, the model object (F) may include a label field and a fieldtype field.

In this case, a content of a label field of a first record of the model object (F) may be displayed on the filtering condition input window 200 of FIG. 1. Further, a type of the user input interface (=user input component) for receiving the filtering condition of the label field of the first record may be determined by a value of the fieldtype field of the first record.

A certain specific model object (F) is predefined by the developer or the like as necessary, and in this case, a content of the specific model object (F) may not be changed by the LM. However, the LM is configured to select any one model object (F) from among the plurality of model objects (F) according to the natural language command input into the LM. That is, the LM may output an ID for identifying any one model object (F) selected from the plurality of model objects (F).

The LM may output the model object (F) and the model object (O) in response to the natural language command. A type of the user input interface (=user input component) of the application program may be determined by the model object (F). The detailed description thereof will be described below.

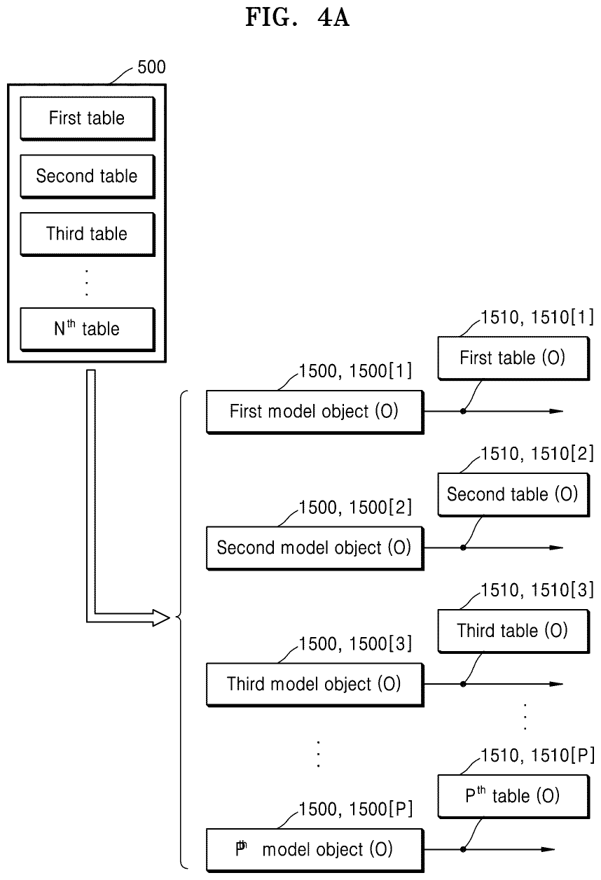

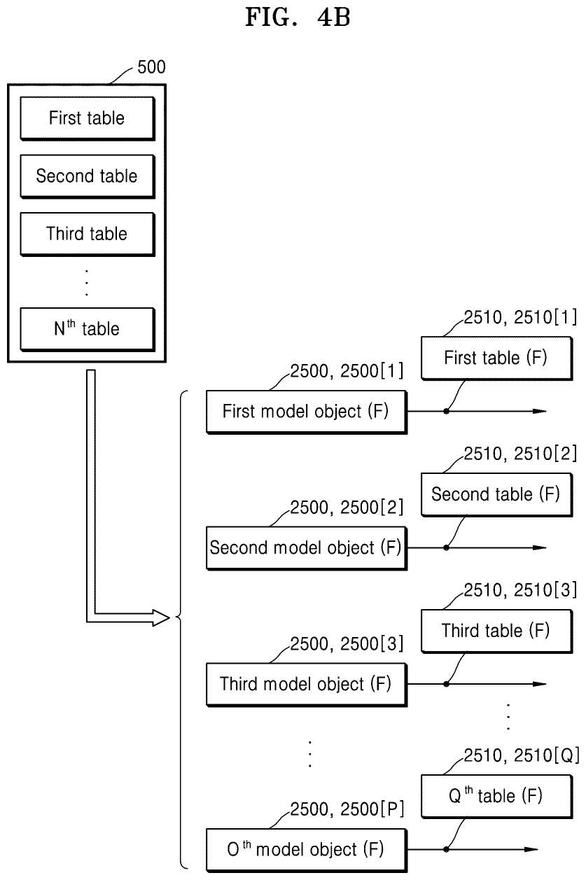

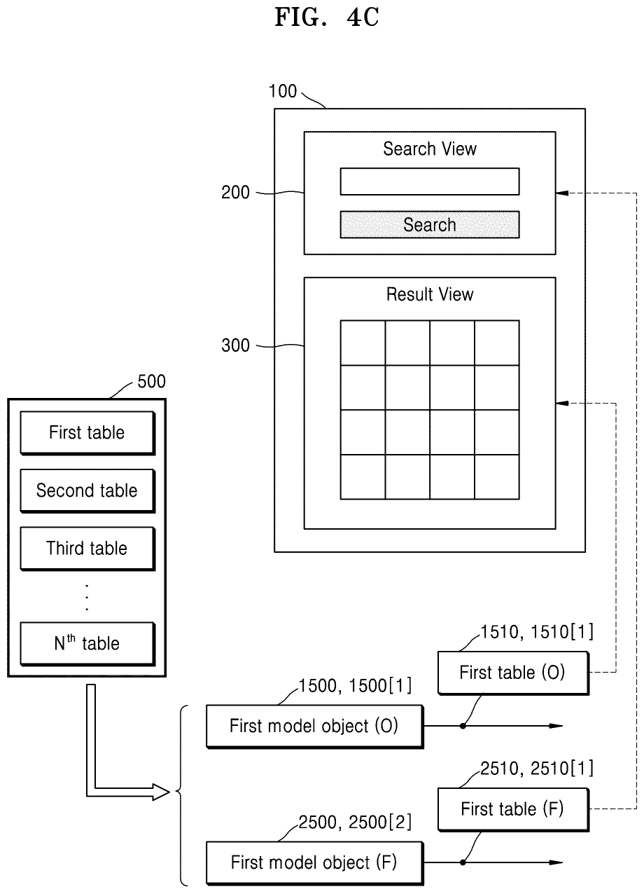

FIG. 4A is a diagram illustrating a process of preparing a new table from a pre-prepared group of tables by a pre-prepared model object (O) according to one embodiment of the present invention.

FIG. 4B is a diagram illustrating a process of preparing a new table from a group of pre-prepared tables by a pre-prepared model object (F) according to one embodiment of the present invention.

FIG. 4C is a diagram illustrating a concept in which tables, which are generated by the pre-prepared model object (O) and model object (F), respectively, are used to generate a condition input window and a condition output window of FIG. 1, according to one embodiment of the present invention.

Hereinafter, the description will be given with reference to FIGS. 4A to 4C.

A plurality of model objects (O) 1500 illustrated in FIG. 4A may be pre-prepared. The LM may output an identifier indicating any one of the plurality of model objects (O) 1500. One model object (O) 1500 is configured to generate a new table 1510 by combining a plurality of pre-prepared tables 500.

A plurality of model objects (F) 2500 illustrated in FIG. 4B may be pre-prepared. The LM may output an identifier indicating any one of the plurality of model objects (F) 2500. One model object (F) 2500 is configured to generate a new table 2510 by combining a plurality of pre-prepared tables 500. The table 2510 output by the model objects (F) 2500 may include information defining attributes of columns included in the table 1510 output by the model object (O) 1500.

For example, the plurality of tables 500 may include a first table including name/address/phone number columns, a second table including an educational background column, and a third table including a career column. In addition, the table 1510 output by the model object (O) 1500 may be reconfigured to include, for example, the name/address/phone number/educational background/career columns. The table 2510 output by the model objects (F) 2500 may be a table including information defining attributes of columns indicating the name/address/phone number/educational background/career.

For example, the information defining an attribute of the first column from among the plurality of columns generally includes a label of the first column, a datasize of the first column, and a datatype of the first column. According to one preferred embodiment of the present invention, the information defining the attributes of the first column further includes a fieldtype of the first column. A function of the fieldtype is as described above.

When the LM outputs an identifier indicating a first model object (O) 1500[1] and a first model object (F) 2500[1], the processing engine provided according to one embodiment of the present invention may prepare a first table (O) 1510[1] using the first model object (O) 1500[1] and prepare a first table (F) 2510[1] using the first model object (F) 2500[1].

The processing engine may generate a command code for outputting the condition input window 200 of FIG. 1 by using a view template object indicated by an identifier of the view template object output by the LM, an action object indicated by the identifier of the action object output by the LM, and the first table (F) 2510[1].

In addition, the processing engine may generate a command code for outputting the output window 300 of FIG. 1 by using the view template object indicated by the identifier of the view template object output by the LM, the action object indicated by the identifier of the action object output by the LM, and the first table (O) 1510[1].

### <View Template Object>

According the present invention, the view template object output from the LM may include a view template object (O) and a view template object (F).

According to the present invention, the view template object (O) output by the LM may refer to an instruction set used to process a pre-prepared data set in a specific design format using the model object (O) output by the LM and output the data set.

In addition, according to the present invention, the view template object (F) output by the LM may refer to an instruction set used to generate a predetermined condition input window by using the model object (F) output by the LM.

It may be understood that different view template objects mean different instruction sets. The instruction set may be JavaScript.

The data set managed by the model object (F) selected by the LM may be visually displayed according to any one visualization format selected from among various visualization formats, and in this case, the view template object (O) may be associated with any one selected visualization format.

According to the present invention, mutually different view template objects (O) may be associated with mutually different visualization formats. For example, the view template object (O) may be a design template expressing the data set managed by the model object (F) in a format of a two-dimensional pie chart, a three-dimensional pie chart, a vertical bar chart, or a grid including R rows and C columns. The present invention is not limited to the above-described examples.

In this case, the visualization format associated with the view template object (O) is an abstract concept in itself and has no specificity. However, when data of the table generated by a specific model object (O) is applied to the visualization format associated with the view template object (O), the visualization format may be visually expressed in a meaningful shape.

Therefore, in order for the visualization format associated with the view template object (O) to be generated to express a valid meaning on the display screen, the visualization format associated with the view template object (O) needs to be specified by data of the table generated by the specific model object (O). According to the present invention, a certain model object (O) may be selected by the LM.

That is, the visualization format associated with the view template object (O) may be understood as a design template for processing the data set of the table generated in the model object (O) selected by the LM and “outputting” the data set to the user in a specific expression format. That is, the view template object (O) is defined for outputting the information to the user.

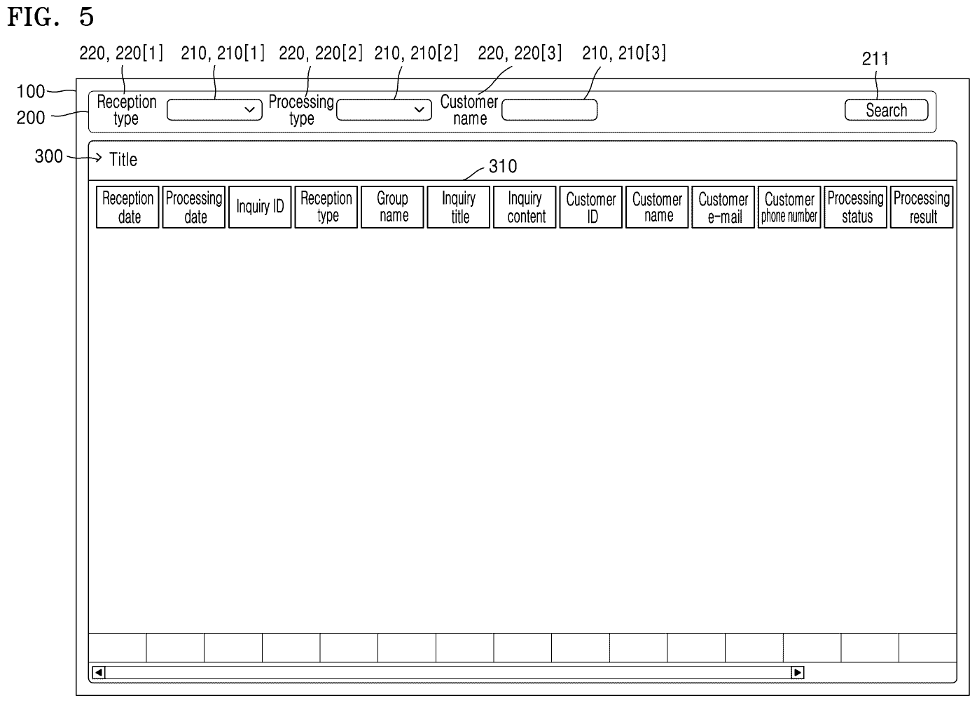

FIG. 5 is a diagram illustrating still another example of the application program shown in FIG. 1.

The application program illustrated in FIG. 5 is generated based on the model object (F) illustrated in FIG. 3B.

Although only one user input component 210 for inputting the data filtering condition in the filtering condition input window 200 is shown in the example of FIG. 1, a total of three user input components 210 are shown in the example of FIG. 5. In addition, in FIG. 5, a label 220 indicating a target of each user input component 210 is displayed as text on the left side of each user input component 210.

In FIG. 5, reference numerals 220[1], 220[2], and 220[3] respectively indicate “reception type”, “processing type”, and “customer name”, which may also be confirmed in FIG. 3B.

In FIG. 5, a user input interface (=user input component) expressed by reference numeral 210[1] is provided as a combo component of a SelectOne type for selecting one of a plurality of predetermined types representing the “reception type”. This is because, in the third row of FIG. 3B, the label of “reception type” is associated with the fieldtype of “SelectOne”.

In FIG. 5, a user input interface (=user input component) expressed by reference numeral 210[2] is provided as a combo component of a SelectOne type for selecting one of a plurality of predetermined types representing the “processing type”. This is because, in the fourth row of FIG. 3B, the label of “processing type” is associated with the fieldtype of “SelectOne”.

In FIG. 5, a user input interface (=user input component) expressed by reference numeral 210[3] is provided as an Edit component of a FreeText type capable of freely inputting a “customer name”. This is because, in the sixth row of FIG. 3B, the label of “customer name” is associated with the fieldtype of “FreeText”.

As such, a specific value of fieldtype defined in the model object (F) illustrated in FIG. 3 determines an expression method of the user input component 210 for inputting the data filtering condition to be expressed in the application program (that is, a view template indicating the user input component 210 for inputting the data filtering condition).

A plurality of expression methods may be predefined and prepared as an expression method (=a view template for a user input) of the user input component 210 for inputting the data filtering condition to be expressed in the application program.

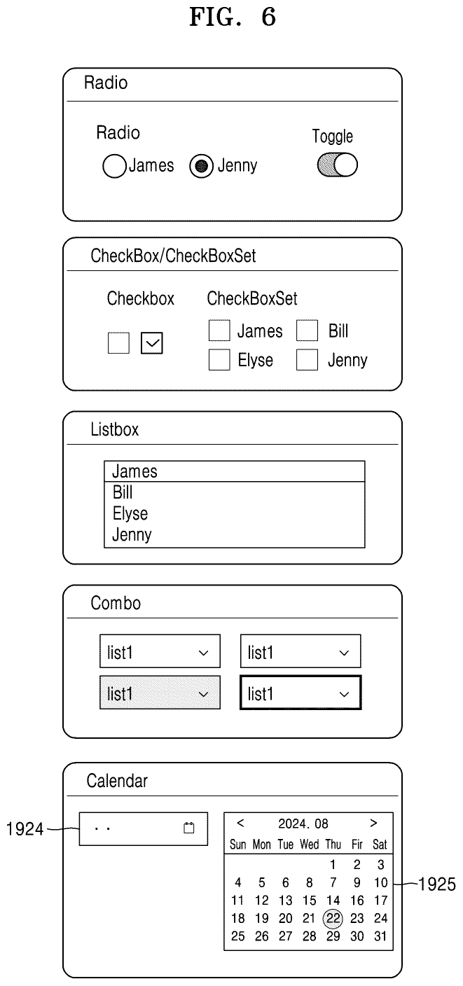

FIG. 6 is a diagram illustrating an example of the plurality of expression methods (=view templates for user inputs).

The user input interface (=user input component) shown in FIG. 6 is familiar to those skilled in the art, but is exemplified to clarify the meaning of the user input component 210 of the present invention. For example, at the bottom of FIG. 6, a user input component named Calendar is shown, wherein the left portion thereof shows a user input controller 1924 that triggers an output of a calendar 1925 shown on the right side. The calendar 1925 is a user input component that selects a specific date from a typical calendar that shows all dates of a specific month at intervals of a week.

If a fieldtype associated with a certain label shown in FIG. 3B is defined as “Calendar”, a user input component in a calendar format at the bottom of FIG. 6 may be provided as the filtering condition input window 200 of the application program as illustrated in FIG. 5.

According to one embodiment of the present invention, the user input component may be a button component, a radio component, a listbox component, a check box component, a combo component, a multicombo component, an edit component, a maskedit component, a grid component, a textarea component, or a calendar component for user input. The user input component defined by the present invention is not limited to the above-described components.

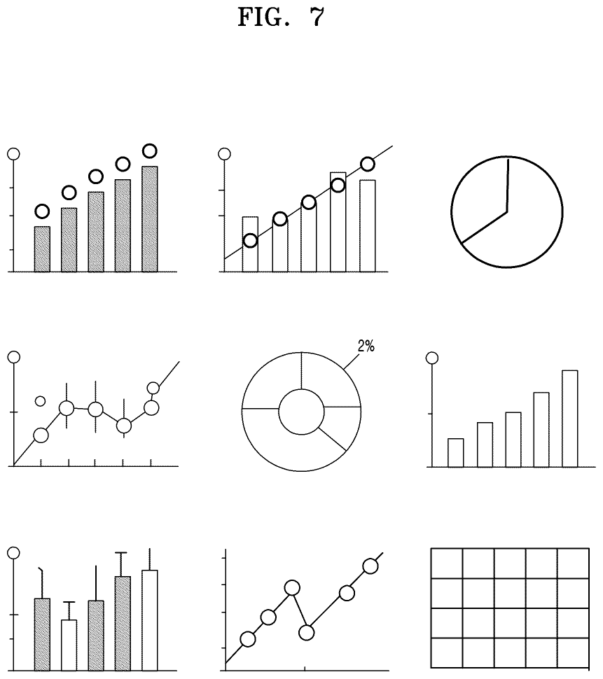

FIG. 7 is a diagram illustrating various types of design templates of a visualization format associated with a view template object (O) that is selected by an LM provided according to one embodiment of the present invention.

Although the user output information 310 is shown in a grid format in FIG. 5, the user output information 310 may be output in the form of various expressions presented in FIG. 7 according to the view template object (O) selected by the LM.

### <Action Object>

In the present specification, an action object refers to a set of instructions for visualizing data of the table generated by the model object (O) in a visualization format associated with the view template object (O), based on the model object (O) and the view template object (O) selected by the LM and outputting the visualized data on a display screen. The set of instructions may be, for example, JavaScript.

In this case, the action object may output a result, in which the data set of the table generated by the model object (O) is filtered according to the data filtering condition input by the user input component, on the screen according to the visualization format. Accordingly, the execution of the action object may be started at a time point when the user clicks the trigger button 211 after the data filtering condition is input by the user.

As described above, the data of the table generated by the model object (O) is ideological in itself, and the visualization format associated with the view template object (O) are conceptual in itself, and when the data of the table and the visualization format are combined with each other, the data of the table and the visualization format may be specifically recognized by a person in a meaningful format.

The processing engine may generate an executable code of the application program based on the model object (O), the model object (F), the view template object (O), the view template object (F), and the action object, which are selected by the LM.

### <Fine-Tuning of LM>

In this case, the LM may be a program including a set of instructions that cause the computing device to execute a step of receiving the natural language command and generating the output information corresponding to the input natural language command. In this case, the LM may be prepared through a process of fine-tuning an LM that is given in advance.

The generation of the output information may mean that the LM generates an identifier indicating the model object (O), the model object (F), the view template object (O), the view template object (F), and the action object, which are selected by the LM.

According to one embodiment of the present invention, the method for developing an application program of a computing device may include a step S130 of generating, by the processing engine, an execution code of the application program based on the output information generated by the LM. When the user executes the execution code of the application program, the application program may be executed.

### <Execution of Application Development Program>

The executing of the method for developing an application program may include executing a program for developing an application including instructions for executing each of the above-described steps S100, S110, S120, and S130.

When the computing device executes the application development program, the computing device may execute the above-described steps S100, S110, S120, and S130 to generate the execution code of the application, that is, the application program.

It should be understood that the application development program and the application program are mutually different from each other. As a result of executing the application development program, the application program may be generated.

According to one embodiment, a person who executes the application development program may be a developer (a low-code developer), and a person who executes the application program may be a user other than the developer.

### <Execution of Application Program>

As described above, the output information may include an identifier indicating the model object (O), the model object (F), the view template object (O), the view template object (F), and the action object, which are selected by the LM.

In this case, when the execution code (=application program) of the application program is executed, the window 100 illustrated in FIGS. 1 and 5 is output. When the user inputs a data filtering condition to one or more user input components of the set of user input components and clicks the trigger button 211, the action object is executed. When the action object is executed, information filtered by the data filtering condition among data of the table generated by the model object (O) may be output on the screen in an expression format expressed by the view template object (O). That is, even if the execution code (=application program) of the application is executed, the action object is not immediately executed, but the action object may be executed only when the trigger button 211 is clicked.

### <Fine-Tuning of LM>

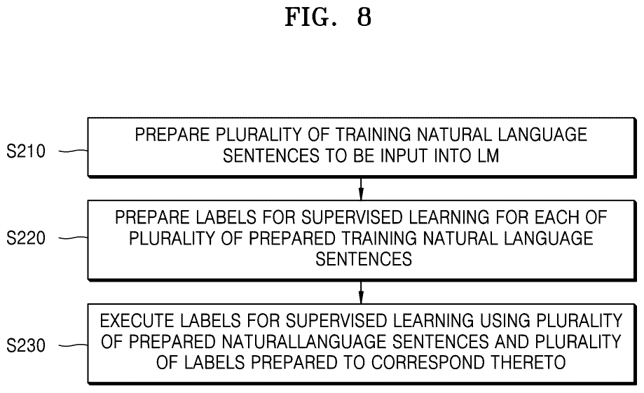

The LM in operation S110 of FIG. 2 may be fine-tuned from the LM provided by the third party. The fine-tuning process may include an LM learning method of performing supervised learning of the LM according to one aspect of the present invention. The LM learning method may include the following steps described with reference to FIG. 8.

FIG. 8 is a flowchart illustrating a language model learning method provided according to one embodiment of the present invention.

The LM learning method may include a step S210 of preparing a plurality of training natural language sentences to be input into the LM.

According to one preferred embodiment, each of the natural language sentences may be prepared in a format including words and/or phrases corresponding to the model object (O), the model object (F), the view template object (O), the view template object (F), and the action object. The part of speech of the word may be a noun or a verb, but is not limited thereto.

In this case, the words and/or phrases, which correspond to the model object (O), the model object (F), the view template object (O), the view template object (F), and the action object, respectively, may mean words and/or phrases that mean, imply, or are associated with each of the above. Alternatively, even if the corresponding words and/or phrases are not specified in the natural language sentence, it may be inferred that the corresponding words and/or phrases exist based on the context of the natural language sentence.

In this case, the model object (F) may be selected from the plurality of model objects (F) distinguished from each other.

In this case, the model object (O) may be selected from the plurality of model objects (O) distinguished from each other.

In this case, the view template object (F) may be selected from a plurality of design templates distinguished from each other.

In this case, the view template object (O) may be selected from the plurality of design templates distinguished from each other.

In this case, the action object may be selected from a plurality of action objects distinguished from each other.

The plurality of prepared natural language sentences may include all possible combinations of words and/or phrases specifying the model object (O), the model object (F), the view template object (O), the view template object (F), and the action object. In addition, in a state where a first set of words and/or phrases that represent the first model object (O), the first model object (F), the first view template object (O), the first view template object (F), and a first action object are given, there are various ways to compose the first set of words and/or phrases into a single sentence, and thus, there may be a plurality of natural language sentences that include the first set of words and/or phrases.

For example, when a request “Make as many natural language sentences as possible that may include the first set of words and/or phrases!” is input into a conventional generative LLM model, the LLM model may provide a plurality of natural language sentences that may include the first set of words. When the process is performed for all possible combinations of the plurality of model objects distinguished from each other, the plurality of view template objects distinguished from each other, and words representing the plurality of action objects distinguished from each other, a large number of natural language sentences may be prepared.

The LM learning method may include a step S220 of preparing labels for each of the plurality of prepared training natural language sentences.

Each of the prepared natural language sentences may be used as input data for training the LM. According to one aspect of the present invention, when each of the learning natural language sentences is input into the LM, the fine-tuned LM to be prepared may output a model object (F) (or a word and/or phrase representing the model object (F)) included in the learning natural language sentence input by the LM among a plurality of prepared model objects (F), a model object (O) (or a word and/or phrase representing the model object (O)) included in the learning natural language sentence input by the LM among a plurality of prepared model objects (O), a view template object (F) (or a word and/or phrase representing the view template object (F)) included in the learning natural language sentence input by the LM among a plurality of prepared view template objects (F), a view template object (O) (or a word and/or phrase representing the view template object (O) included in the learning natural language sentence input by the LM among a plurality of prepared view template objects (O), and an action object (or a word and/or phrase representing the action object) included in the learning natural language sentences input by the LM among a plurality of prepared action objects.

To this end, the LM may be subject to supervised learning. In this case, a supervised learning label for a specific learning natural language sentence to be input into the LM may include a word representing a model object (F) evaluated as being indicated by the input learning natural language sentence, a word representing a model object (O) evaluated as being indicated by the input learning natural language sentence, a word representing the view template object (F) included in the input learning natural language sentence, a word representing the view template object (O) included in the input learning natural language sentence, and a word representing the action object included in the input learning natural language sentence.

The LM learning method may include a step S230 of performing supervised learning on the LM using the plurality of prepared training natural language sentences and a plurality of labels prepared corresponding thereto.

### Implementation Example 1

Hereinafter, in order to help understanding of the present invention, a specific example of the natural language command input into the application development program by the developer for developing the application program, output information output by the LM suitably trained to process the natural language command, and an example of a screen output by the application program generated by a predetermined processing engine using the output information are shown.

For example, the developer may execute the application development program and input the natural language command into the application development program, “Please create an application program that filters the production items and inquiry periods to output the production amount of the production items in a bar chart according to the period!”.

In that case, the fine-tuned LM used by the application development program may output information specifying \textcircled{1} a model object (F) used to generate a user input controller capable of filtering a production item and an inquiry period, \textcircled{2} a model object (O) used to manage a data set related to a production amount of the production item, \textcircled{3} a view template object (F) used to select a design format of the user input controller, \textcircled{4} a view template object (O) used to output the data set as a bar chart, and \textcircled{5} an action object used to output the model object (O), the model object (F), the view template object (O), and the view template object (F) in association with each other.

For example, the information output by the LM may have a format such as {xModel(F): “xMF[productionDB]”, xModel(O): “xMO[productionDB]”, Templete(F): “Calendar and Combo Button”, Templete(O): “Bar Chart”, Action: “Inquiry”}. This is an example to help understanding of the present invention, and the present invention is not limited thereto, where xModel(F) represents the model object (F), xModel(O) represents the model object (O), Template(F) represents the view template object (F), Template(O) represents the view template object (O), and Action represents the action object.

In contrast, for example, if the developer may execute the application development program and input the natural language command into the application development program, “Please create an application program that filters the discarded items and inquiry periods to output the discard amount of the discarded items in a bar chart according to the period!”. In this case, the information output by the LM may include {xModel(F): “xMF[discardDB]”, xModel(O): “xMO[discardDB]”, Templete(F): “Calendar and Combo Button”, Templete(O): “Bar Chart”, Action: “Inquiry”}.

In order to help the understanding of the present invention, the application program exemplified in the present specification is for executing a “data inquiry” function. Therefore, the above-described action shows an example of an “inquiry” action. However, the application program may execute a function other than the “data inquiry”. Therefore, the action for each application program may be an action other than the “inquiry”. For example, according to the purpose of the application program, the action may be variously defined and prepared, such as “message pop-up”, “data copy”, “AI data analysis request”, “Excel Import”, “Excel Export”, and the like.

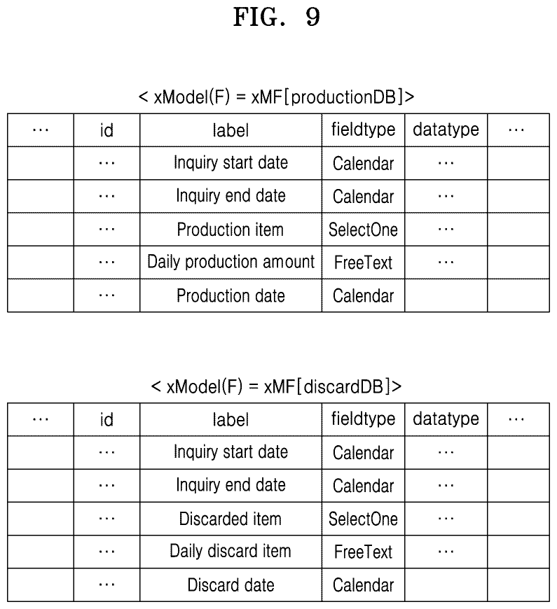

FIG. 9 is a diagram illustrating two mutually different model objects (F) that may be output by the LM.

The upper part of FIG. 9 shows xModel(F)=xMF[productionDB], and the lower part of FIG. 9 shows xModel(F)=xMF[discardDB].

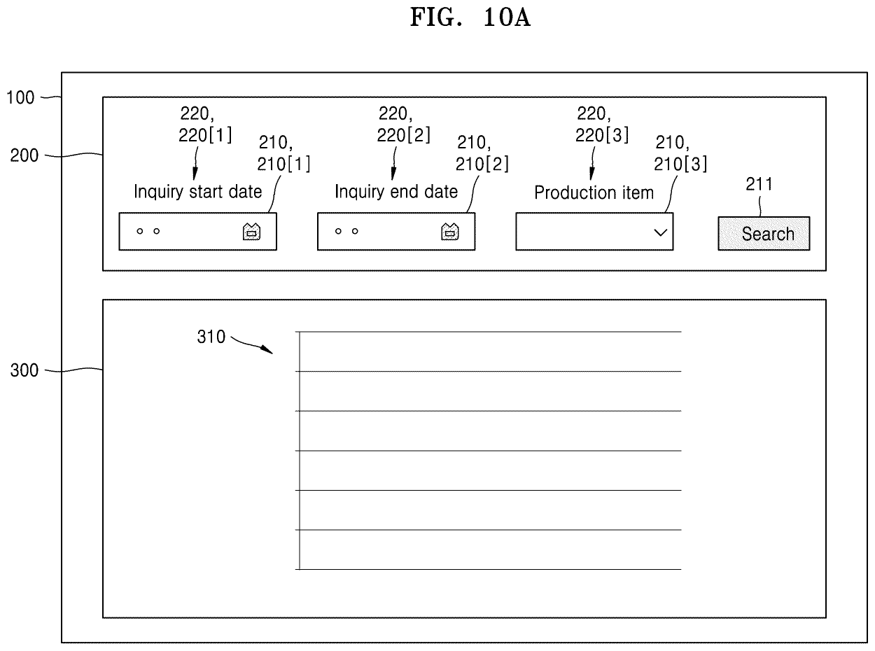

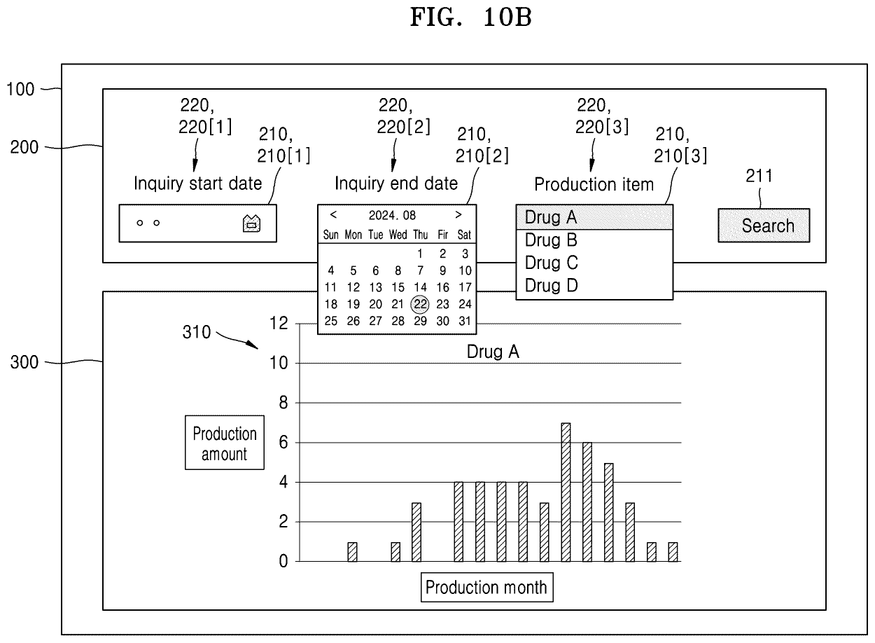

FIGS. 10A and 10B are diagrams illustrating examples of a screen output by an application program generated by the processing engine using the output information.

When the application program is executed, a screen as illustrated in FIG. 10A may be output.

Since the natural language command input by the developer is “Please create an application program that filters the production items and inquiry periods to output the production amount of the production items in a bar chart according to the period!”, the filtering condition input window 200 shows user input components 210[1], 210[2], and 210[3] capable of filtering an inquiry start date 220 [1], an inquiry end date 220 [2], and the production item 220[3], which are labels included in the model object (F) (xModel (F)=xMF [productionDB]).

FIG. 10B illustrates a case where the user of the application program inputs the data filtering condition and clicks the trigger button 211, the action: “inquiry” is executed and the user output information 310 is displayed in a specific design.

On the other hand, if the natural language command input by the developer is “Please create an application program that filters the inquiry period to output the production amount in a bar chart according to the period!”, the user input component 210[3] and the label 220[3] are not output on the filtering condition input window 200, and the user output information 310 may be displayed to include all types of production items.

### Implementation Example 2

Hereinafter, in order to help understanding of the present invention, a specific example of the natural language command input into the application development program by the developer in order to develop the application program, output information output by the LM suitably trained to process the natural language command, and another example of a screen output by the application program generated by a predetermined processing engine using the output information are shown.

For example, the developer may execute the application development program and input the natural language command into the application development program, “Please create an application program that filters all conditions to output the production amount of the production items in a bar chart according to the period!”. In this case, the information output by the LM may include {xModel(F): “xMF[productionDB]”, xModel(O): “xMO[productionDB]”, Templete(F): “Calendar and Combo Button”, Templete(O): “Bar Chart”, Action: “Inquiry”} as described above.

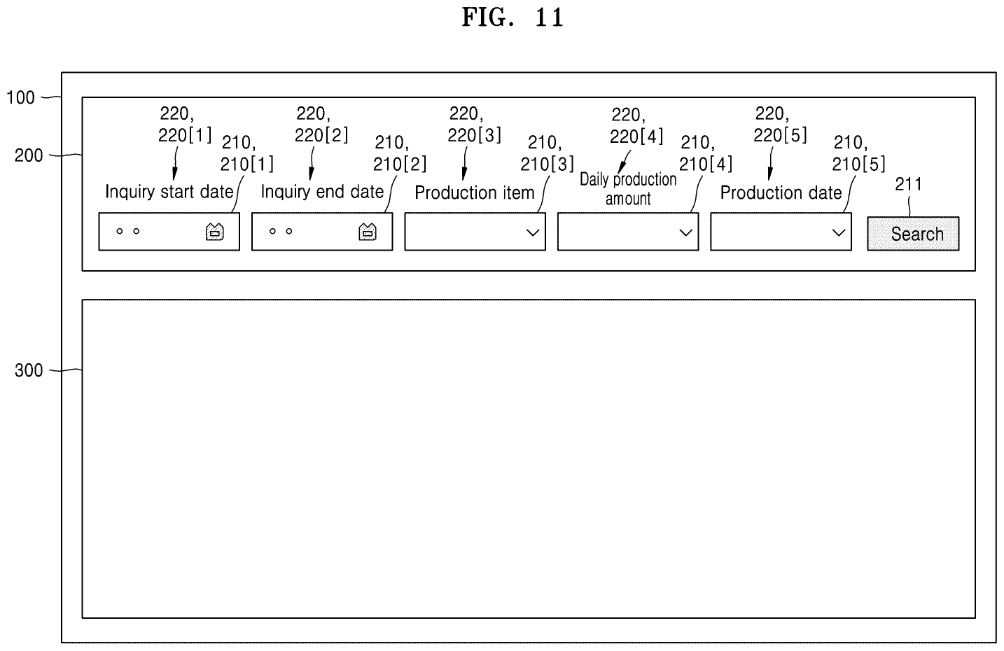

FIG. 11 is a diagram illustrating an example of a screen output by an application program generated by the processing engine using the output information, which is provided according to one embodiment of the present invention.

The processing engine may display the user input components for filtering all the labels filterable in the model object(F) (xMF[productionDB]) on the filtering condition input window 200 as shown in FIG. 11.

The developer may check the filtering condition input window 200 of FIG. 11 and, if satisfied, distribute the application program generated by the processing engine to the user.

On the other hand, if the developer is not satisfied with the filtering condition input window 200 of FIG. 11, the developer may develop the application program again by modifying the natural language input again. For example, when it is determined that data filtering using a “daily production amount” 220[4] and a “production date” 220[5] among five user input components shown in FIG. 11 is not required, the application program may be redeveloped by inputting the natural language command “Please create an application program that filters all conditions except for the daily production amount and the production date to output the production amount of the production items in a bar chart according to the period!” into the application development program. In this way, the application development program provided according to the present invention may generate an application program as illustrated in FIG. 9a.

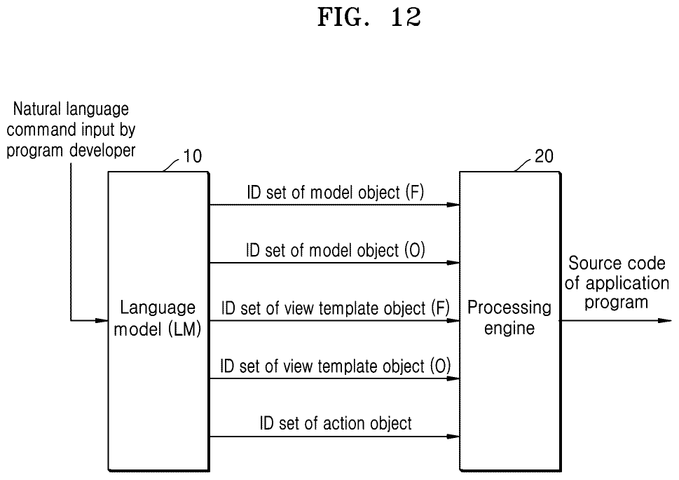

FIG. 12 is a functional block diagram illustrating a configuration of an application development program, which is provided according to one embodiment of the present invention.

The program developer may input the natural language command into the computing device.

The natural language command may be provided to a fine-tuned language model (LM) 10.

The LM 10 may be an application program executed in the computing device or another computing device, and may include a first set of command codes.

The LM 10 may select at least one of the model object (O), the model object (F), the view template object (O), the view template object (F), and the action object in response to the natural language command. Although only one condition input window and only one output window are shown in the window 100 illustrated in FIG. 1, the program developer may want to develop an application program including a larger number of windows 100, and the LM 10 may also be fine-tuned to output output information for a plurality of condition input windows and/or a plurality of output windows. In consideration of this, FIG. 12 illustrates that the LM 10 outputs a set including IDs of one or more model objects (O), a set including IDs of one or more model objects (F), a set including IDs of one or more view template objects (O), a set including IDs of one or more view template objects (F), and a set including IDs of one or more action objects, in response to the natural language command.

The processing engine 20 may be an application program executed in the computing device or another computing device, and may include a second set of command codes. The processing engine 20 may generate a source code or an execution code of the application program based on the output information of the LM 10, and output the source code or the execution code.

The LM may be a small language model (sLLM).

The large language model (LLM) and the small language model (sLLM) are different in terms of size and use. These differences relate to the size, performance, use case, and distribution and maintenance of the model. Hereinafter, main differences between the LLM and the sLLM will be described.

The LLM is a large language model, and may have billions to hundreds of billions of parameters, for example. For example, GPT-3 has 175 billion parameters. As the size is large, more data and computational resources are required. The LLM may provide a higher level of performance and accuracy through a large amount of parameters, exhibits better performance in complex language understanding and generation, and has excellent generalization capabilities in various domains. The LLM is used for a variety of tasks that require high performance, such as complex question-and-answer systems, interactive AI, text generation, and language translation. For example, the LLM may be used as a customer service chatbot, an automatic writing tool, a research and analysis tool, and the like. The LLM requires more computational resources and storage space, and because of its high deployment and operating costs, the LLM is often deployed through cloud-based services or large-scale infrastructure. The LLM requires a large amount of data and a long learning time, requires a large amount of computing resources in the learning process, and model-tuning and fine-tuning may be complicated and time-consuming. An example of the LLM is GPT-3, which is a large language model that exhibits very high performance in general-purpose text generation and understanding operations.

The sLLM is a small language model, and may have, for example, 7 billion to 70 billion parameters. The sLLM is small, so that learning and inference are possible with less data and computational resources. The sLLM may perform less than the LLM, but may be useful enough for a particular task or domain. The sLLM may perform general language understanding and generation tasks, but may have limitations in complex tasks. The sLLM may provide an efficient and fast response when tuned for a specific purpose. The sLLM is used for relatively simple tasks or tasks specialized for a specific domain. For example, the sLLM may be used for a simple FAQ chatbot, text classification in a specific domain, object recognition, and the like. Since the sLLM requires relatively small computational resources and storage space, and has low deployment and operation costs, the sLLM is highly flexible because sLLM may be executed in on-premises environments or edge devices. The sLLM may create an effective model even with a relatively small amount of data and a short learning time, so that model-tuning and fine-tuning may be performed more easily and quickly. The Llama-2™ model released by Meta™ is a representative sLLM model, and has the size of the parameter of 7 billion to 70 billion. In addition, the Solar™ model of Upstage™, which is customized based on Llama-2 and released in accordance with Korean language specialization, has 10.7 billion parameters.

As such, the LLM and the sLLM may be selectively used according to their strengths and weaknesses and uses. The LM used in the present invention may be an sLLM having an advantage of being efficiently used even in a light-weight environment.

In general, a method for fine-tuning a small language model (sLLM) through supervised learning may include the following steps. This process is to obtain better performance by adjusting a pre-trained model to suit a specific task. According to the present invention, the LM learning method of supervised learning of the LM may follow the general sLLM supervised learning method.

The method for fine-tuning the sLLM through supervised learning may include a step S310 of collecting and pre-processing data. A data set with labels required for the job is collected. For example, a data set having each text and a label corresponding thereto may be prepared for a text classification task. In addition, it is possible to perform a data arrangement process of normalizing text data and removing unnecessary characters or spaces. In addition, a data division process of dividing the data set into a training set and a verification set may be performed. In general, the training set and the validation set are divided into an 80:20 ratio, but the ratio may be adjusted according to the amount of data and work.

The method for fine-tuning the sLLM through supervised learning may include a step S320 of loading the pre-trained model. For example, a pre-trained small language model to be used in a place such as a Hugging Face Transformers library may be selected. For example, a Llama-2™ model or a Solar™ model may be selected. In addition, the selected pre-trained model may be loaded.

The method for fine-tuning the sLLM through supervised learning may include a dataset tokenizing step S330 of converting text data into a token using a tokenizer to input the text data into the model.

The method for fine-tuning the sLLM through supervised learning may include a model fine-tuning step S340 of setting parameters necessary for training, such as an optimizer and a learning rate, and fine-tuning the model using training data.

The method for fine-tuning the sLLM through supervised learning may include a model evaluation and verification step S350 of evaluating the performance of the model using verification data.

The method according to the embodiment may be implemented in the form of program instructions to be executed through various computing mechanisms, thereby being recorded in a non-volatile recording medium. For example, the non-volatile recording medium is a non-transitory computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like as well as a machine code generated by a compiler.

According to the present invention, the method for performing supervised learning on the LM may include steps of the method for fine-tuning the above-described sLLM through supervised learning.

According to the embodiment to help understanding of the present invention, the concept of “view template object(O)” is shown. The “view template object(O)” is a concept corresponding to a case of providing a visual output as an output to the user. Even if an auditory output is provided as an output for the user, various types of “audio template objects (O)” may be defined and provided. Accordingly, the concept and the term of “output template” may be defined as a higher concept of the concept of “view template” and “audio template”. Therefore, it may be understood that the term and concept of “view template” shown in the present specification may be replaced with the term “output template”, and the present invention may extend to this point.

Using the above-described embodiments of the present invention, those skilled in the art of the present invention will easily implement various changes and modifications without departing from the essential features of the present invention. The content of each claim in the claims may be combined with other claims that do not have a citation relationship within the scope that may be understood through the present specification.

What is claimed is:

1. A method for generating an application program, the method comprising:
inputting, by a computing device, a natural language command through a developer input interface from a developer who develops the application program;
inputting, by the computing device, the input natural language command into a predetermined language model (LM);
acquiring, by the computing device, predetermined output information generated by the language model in response to the input of the natural language command; and
generating, by the computing device, a source code or an execution code of the application program using the acquired output information,
wherein the output information includes:
a model object (O) configured to generate a table including data required by a user of the application program;
a view template object (O) used to output the data required by the user on a screen in a predetermined expression format; and
an action object configured to output the data required by the user on the screen in the predetermined expression format, and
wherein the action object is executed when a trigger button, which is provided by the application program being executed, is selected by the user.

2. The method of claim 1, wherein the output information further includes:
a model object (F) configured to generate a table including information about a user input component for receiving a data filtering condition from the user, and
a view template object (F) used to generate a condition input window including the user input component, and
wherein the action object is configured to filter the data required by the user using the data filtering condition to output the filtered data, which is prepared by filtering, on the screen in the predetermined expression format.

3. The method of claim 1, wherein the language model has been subject to supervised learning, and
wherein a method of the supervised learning includes:
preparing a plurality of training natural language sentences to be input into the language model;
preparing labels for each of the plurality of prepared training natural language sentences; and
performing supervised learning on the language model by using the plurality of prepared training natural language sentences and a plurality of labels prepared to correspond to the plurality of prepared training natural language sentences.

4. The method of claim 3, wherein the output information includes:
a model object (F) configured to generate a table including information about a user input component for receiving a data filtering condition from the user of the application program;
the model object (O) configured to generate the table including the data required by the user;
a view template object (F) used to generate a condition input window including the user input component;
the view template object (O) used to output the data required by the user on the screen in the predetermined expression format; and
the action object configured to filter the data required by the user using the data filtering condition to output the filtered data, which is prepared by filtering, on the screen in the predetermined expression format, and
wherein each of the labels is configured in a combination of:
any one of words representing a plurality of pre-prepared model objects (F);
any one of words representing a plurality of pre-prepared model objects (O);
any one of words representing a plurality of pre-prepared view template objects (F);
any one of words representing a plurality of pre-prepared view template objects (O); and
any one of words representing a plurality of pre-prepared action objects.

5. A non-volatile recording medium recorded with an application development program that causes a computing device to generate an application program,
wherein the application development program includes instructions that cause the computing device to execute the steps of:
inputting a natural language command through a developer input interface from a developer who develops the application program;
inputting the input natural language command into a predetermined language model;
acquiring predetermined output information generated by the language model in response to the input of the natural language command; and
generating a source code or an execution code of the application program using the acquired output information,
wherein the output information includes:
a model object (O) configured to generate a table including data required by a user of the application program;
a view template object (O) used to output the data required by the user on a screen in a predetermined expression format; and
an action object configured to output the data required by the user on the screen in the predetermined expression format, and
wherein the action object is executed when a trigger button, which is provided by the application program being executed, is selected by the user.

6. The non-volatile recording medium of claim 5, wherein the output information further includes:
a model object (F) configured to generate a table including information about a user input component for receiving a data filtering condition from the user, and
a view template object (F) used to generate a condition input window including the user input component, and
wherein the action object is configured to filter the data required by the user using the data filtering condition to output the filtered data, which is prepared by filtering, on the screen in the predetermined expression format.

7. The non-volatile recording medium of claim 5, wherein the language model has been subject to supervised learning, and
wherein a method of the supervised learning includes:
preparing a plurality of training natural language sentences to be input into the language model;
preparing labels for each of the plurality of prepared training natural language sentences; and
performing supervised learning on the language model by using the plurality of prepared training natural language sentences and a plurality of labels prepared to correspond to the plurality of prepared training natural language sentences.

8. The non-volatile recording medium of claim 7, wherein the output information includes:
a model object (F) configured to generate a table including information about a user input component for receiving a data filtering condition from the user of the application program;
the model object (O) configured to generate the table including the data required by the user;
a view template object (F) used to generate a condition input window including the user input component;
the view template object (O) used to output the data required by the user on the screen in the predetermined expression format; and
the action object configured to filter the data required by the user using the data filtering condition to output the filtered data, which is prepared by filtering, on the screen in the predetermined expression format, and
wherein each of the labels is configured in a combination of:
any one of words representing a plurality of pre-prepared model objects (F);
any one of words representing a plurality of pre-prepared model objects (O);
any one of words representing a plurality of pre-prepared view template objects (F);
any one of words representing a plurality of pre-prepared view template objects (O); and
any one of words representing a plurality of pre-prepared action objects.
